(19) United States
(12) Patent Application Publication
(10) Pub. No.: US 2009/0112547 A1
(43) Pub. Date: Apr. 30, 2009

(54) Device, System and Method of Underapproximated Model-Checking

(76) Inventors: Arie MATSLIAH, Haifa (IL); Ofer STRICHMAN, Tivon (IL)

Correspondence Address: IBM CORPORATION, T.J. WATSON RESEARCH CENTER, P.O. BOX 218, YORKTOWN HEIGHTS, NY, 10598, US

(21) Appl. No.: 11/926,163

(22) Filed: Oct. 29, 2007

(51) Int. Cl. G06G 7/62

(52) U.S. Cl. 703/13

(57) ABSTRACT

Some demonstrative embodiments include devices, systems and/or methods of model checking. A method of checking a model having a first number of inputs may include, for example, automatically underapproximating the model by an underapproximated model having a second number of inputs, wherein the second number is smaller than the first number, and wherein automatically underapproximating comprises mapping the second number of inputs to the first number of inputs such that any possible combination of two or more values of any subset of two or more respective inputs of the first number of inputs is obtainable by assigning to each of one or more inputs of the second number of inputs a value of a predefined set of input values. Other embodiments are described and claimed.

### FIELD

Some embodiments relate to the field of model checking, including but not limited to formal verification of hardware and/or software designs.

### BACKGROUND

Experience with model checking of designs shows that when a model violates its specification, it may be the case that the values of only some of the inputs are important for triggering an erroneous behavior. Accordingly, an underapproximated model may be used to find erroneous behavior of the design.

Some model-underapproximation methods are based on restricting the number of inputs to the model. For example, one method is to underapproximate the model by manually restricting some of the inputs to constants, and then to gradually lift the restrictions until an error state is reached. Another method is to manually combine sets of inputs, for example, by restricting all inputs in a partition to agree on their value, and then to refine by splitting the combined sets.

However, such underapproximations require user-guidance in order to be effective, unless the erroneous behavior is ubiquitous enough to be very simple to find. For example, the model may not be able to expose an error state if one of the inputs necessary for exposing the error-state is falsely restricted.

### SUMMARY

Some embodiments include devices, systems, and methods of model checking. Some embodiments may allow, for example, reducing a number of explored states in checking of a model by underapproximating the model with an underapproximated model having a reduced number of inputs.

Some demonstrative embodiments include a method of checking a model having a first number of inputs, the method including automatically underapproximating the model by an underapproximated model having a second number of inputs, wherein the second number is smaller than the first number, and wherein the automatically underapproximating includes mapping the second number of inputs to the first number of inputs such that any possible combination of two or more values of any subset of two or more respective inputs of the first number of inputs is obtainable by assigning to each of one or more inputs of the second number of inputs a value of a predefined set of input values.

Some demonstrative embodiments include a computing system capable of checking a model having a first number of inputs, the system including an underapproximator to automatically underapproximate the model with an underapproximated model having a second number of inputs by mapping the second number of inputs to the first number of inputs such that any possible combination of two or more values of any subset of two or more respective inputs of the first number of inputs is obtainable by assigning to each of one or more inputs of the second number of inputs a value of a predefined set of input values, wherein the second number is smaller than the first number.

Some demonstrative embodiments include a computer program product comprising a computer-useable medium including a computer-readable program, wherein the computer-readable program when executed on a computer causes the computer to automatically underapproximate a model having a first number of inputs with an underapproximated model having a second number of inputs by mapping the second number of inputs to the first number of inputs such that any possible combination of two or more values of any subset of two or more respective inputs of the first number of inputs is obtainable by assigning to each of one or more inputs of the second number of inputs a value of a predefined set of input values, wherein the second number is smaller than the first number.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Further, reference numerals may be repeated among the figures to indicate corresponding or analogous elements. Moreover, some of the blocks depicted in the drawings may be combined into a single function. The figures are listed below:

FIG. 1 is a schematic block diagram of a computing system in accordance with some demonstrative embodiments;

FIG. 2 is schematic block diagram of an underapproximated model in accordance with some demonstrative embodiments; and

FIG. 3 is schematic flow chart diagram of a method of underapproximated model checking in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion. It is intended that the embodiments and figures disclosed herein be considered illustrative rather than restrictive.

Portions of the discussion herein utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used herein to describe two or more items; for example, a plurality of items includes two or more items.

Some embodiments may include apparatuses for performing the operations herein. An apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions and capable of being coupled to a computer system bus.

The processes and displays presented herein are not inherently related to any particular computer or other apparatus. Various general-purpose systems may be used with programs in accordance with embodiments herein, or it may be convenient to construct a more specialized apparatus to perform desired methods. In addition, some embodiments are not described with reference to any particular programming, scripting, modeling, and/or hardware description language. A variety of programming and other such languages may be used to implement some embodiments.

Although embodiments of the invention are not limited in this respect, the term “underapproximation” as used herein with reference to a model, denoted M, may refer to performing one or more operations to determine, construct, generate, and/or provide an under-approximated model, denoted M′ corresponding to the model M. The under-approximated model M′ may include a subset of the behaviors of the model M. For example, the model M′ underapproximates the model M if for every property, denoted φ, the model M′ satisfies the property φ if the model M satisfies the property φ, namely, if M|=φ [symbol] M′|=φ. The model M may or may not satisfy the property φ, if the model M′ satisfies the property φ. However, if the model M′ does not satisfy the property φ, then the model M will also not satisfy the property φ.

The property φ may include or may be, for example, a Linear-Temporal-Logic (LTL) property, and/or any other property suitable for model checking. The models M and/or M′ may be or may include, for example, Kripke structures.

Although embodiments of the invention are not limited in this respect, the term “k-universal mapping function” as used herein may refer to a function, for example, a Boolean function, that maps a first number, denoted m, of elements to a second number, denoted n, of elements, wherein m is smaller than n, such that any valuation of a subset of at most k elements of the n elements may be reached under some assignment to one or more of the n elements. For example, the k-universal mapping function may map the m elements to the n elements such that any possible combination of two or more values of any subset of k respective elements of the n elements is obtainable by assigning to each of one or more elements of the m elements a value of a predefined set of input values. The predefined set of input values may include, for example, a set of binary values, e.g., including the values zero and one. The k-universal mapping function may be implemented, for example, as a logical and/or combinatorial circuit, for example, a Boolean circuit. Formally, the k-universal mapping function may be defined, for example, as follows:

For natural numbers k≦m≦n, a mapping function, denoted C:{0, 1}^{m}→{0, 1}ⁿ mapping m elements to n elements is k-universal if for every subset K⊂{1, . . . , n} of k of the n elements and every partial assignment α_{K}ε{0, 1}^{k} on K, there is a full assignment αε{0, 1}^{m} on the m elements such that C(α)|_{K}=α_{K}.

For example, if the function C is k-universal, and the m and n elements include m and n bits, respectively, then any subset of k bits of the n bits may take all 2^{k} possible assignments of the m bits. In one example, e.g., for m=2 and n=3, a function C:{0, 1}²43 {0, 1}³ may be defined as follows:

C(x,y)=(x, y, xXORy)

C(00)=000

C(01)=011

C(10)=101

C(11)=110

According to this example, the function C:{0, 1}²→{0, 1}³ is 2-universal, since every two coordinates of the three coordinates resulting from the function C may include all four possible combinations of the binary values.

In some demonstrative embodiments, the value of k may be very close to the value of m, for example, with an arbitrarily high probability, e.g., as described in detail below.

At an overview, some embodiments include automatic and/or efficient underapproximation-based model checking, for example, for exposing error states, e.g., in heavy verification instances. The underapproximation described herein may reduce the number of inputs being used for verification of a model to be verified while maintaining, for example, a measurable and/or uniform degree of freedom to inputs of the model. In some embodiments the model M, which may have n inputs, may be automatically and/or efficiently underapproximated to define the underapproximated model M′ having m<n inputs, for example, by applying a mapping function to the n inputs. The mapping function may be k-universal, wherein k is at least two, e.g., as described below.

Some demonstrative embodiments include an underapproximator to automatically underapproximate the model M by the underapproximated model M′ based on the desired number of inputs m, which may be defined, for example by a user. For example, the underapproximator may apply a mapping function to expand, for example, the desired m inputs to the n inputs of the model M.

In some embodiments, the mapping function may map the m inputs to the n inputs such that, for example, substantially any possible combination of two or more values of any subset of two or more respective inputs of the n inputs is obtainable by assigning to each of one or more inputs of the m inputs a value of a predefined set of input values, e.g., as described below. Accordingly, the mapping function may be k-universal, wherein k is at least two.

In some embodiments, the mapping function may maintain a degree of freedom equal to k to the n inputs of the model M, for example, such that any valuation of at most k of the n inputs of the model M may be reached under some assignment to the m inputs of the underapproximated model M′. Some demonstrative embodiments may guarantee, for example, high values of k for a given value of m, for example, such that the underapproximated model M′ may be sufficiently complete for locating an error state. For example, if a number of critical inputs necessary for triggering an error state is less than or equal to k, then the underapproximated model M′ resulting from the k-universal mapping may be sufficient, e.g., for triggering the error state.

In some embodiments, the mapping function may be based on a random system, e.g., as described in detail below.

In some demonstrative embodiments, the underapproximated model M′ may be verified more efficiently compared to the model M. For example, the underapproximated M′ may be used to find error states in a design under test while using fewer inputs than the model M and may, for example, require less run-time of the model-checking engine. The underapproximation in accordance with some embodiments may be applicable to Satisfiability (SAT)-based, Binary-Decision-Diagram (BDD)-based model-checking and/or simulation methods and/or systems, and/or any other suitable model-checking and/or simulation methods and/or systems.

Although portions of the discussion herein relate, for demonstrative purposes, to formal verification and/or model-checking techniques and/or methods, some embodiments may be applied to any form of verification, including, for example, simulation-based verification.

Although portions of the discussion herein relate, for demonstrative purposes, to formal verification of hardware and/or software, some embodiments may be used for other formal verifications, for example, verification of a set of laws, of a business process, or the like.

Although portions of the discussion herein relate, for demonstrative purposes, to specifications in Property Specification Language (PSL), some embodiments may be used with any other suitable specifications and/or specification languages, for example, System-Verilog-Assertions (SVA), Computation-Tree-Logic (CTL), and/or others, and/or combinations thereof.

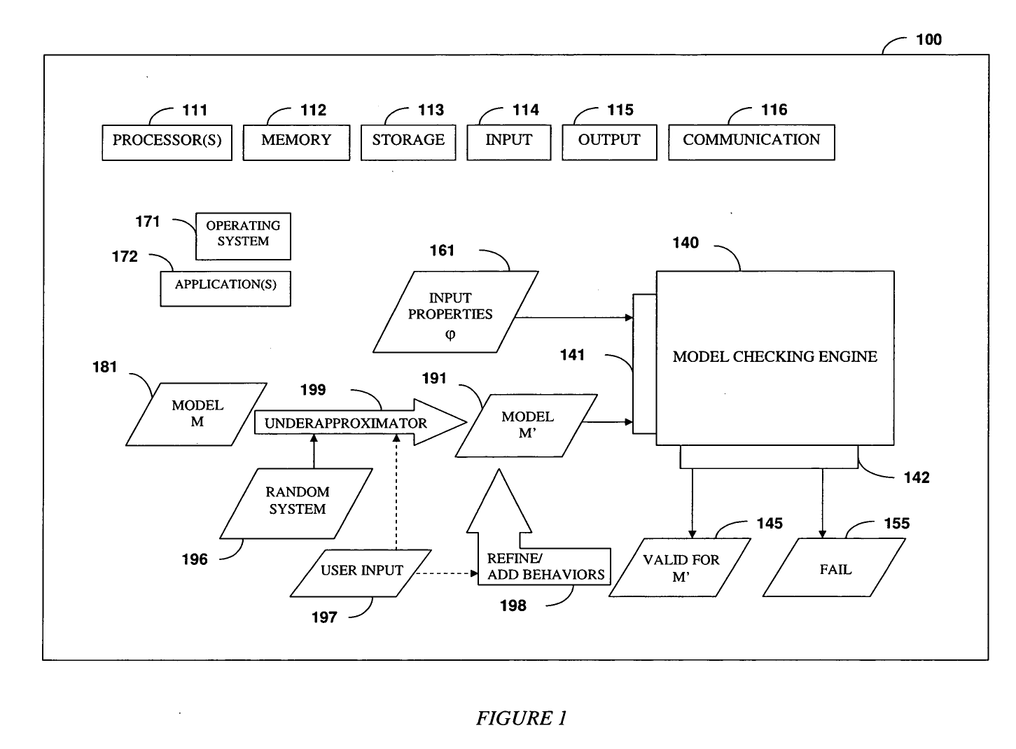

FIG. 1 schematically illustrates a computing system 100 in accordance with some demonstrative embodiments. System 100 may be implemented or may operate using a computing system or a computing device such as, for example, a computer, a personal computer (PC), a server computer, a computing platform, a client/server system, a mobile computer, a portable computer, a laptop computer, a notebook computer, a tablet computer, a network of multiple inter-connected devices, or the like.

System 100 may include, for example, one or more processors 111, a memory unit 112, a storage unit 113, an input unit 114, an output unit 115, and/or a communication unit 116. System 100 may include other suitable hardware and/or software components.

Processor 111 may include, for example, a central processing unit (CPU), a digital signal processor (DSP), a microprocessor, a host processor, a controller, a plurality of processors or controllers, a chip, a microchip, one or more circuits, circuitry, a logic unit, an integrated circuit (IC), an application-specific integrated circuit (ASIC), or any other suitable multi-purpose or specific processor or controller. Processor 111 may execute instructions and process data, for example, of an operating system (OS) 171 or of one or more software applications 172.

Memory unit 112 may include, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit, a long term memory unit, or other suitable memory units or storage units. Memory unit 112 may be coupled to processor 111 by a system bus or other suitable interconnect. Storage unit 113 may include, for example, a hard disk drive, a floppy disk drive, a compact disk (CD) drive, a CD-ROM drive, a digital versatile disk (DVD) drive, or other suitable removable or non-removable storage units. Memory unit 112 and/or storage unit 113 may, for example, store data processed by system 100.

Input unit 114 may include, for example, a keyboard, a keypad, a mouse, a touch-pad, a stylus, a microphone, or other suitable pointing device or input device. Output unit 115 may include, for example, a cathode ray tube (CRT) monitor or display unit, a liquid crystal display (LCD) monitor or display unit, a screen, a monitor, a speaker, or other suitable display unit or output device. Communication unit 116 may include, for example, a wired or wireless network interface card (NIC), a wired or wireless modem, a wired or wireless receiver and/or transmitter, a wired or wireless transmitter-receiver and/or transceiver, a radio frequency (RF) communication unit or transceiver, or other units able to transmit and/or receive signals, blocks, frames, transmission streams, packets, messages and/or data. Communication unit 116 may optionally include or may optionally be associated with one or more antennas.

In some embodiments, the components of system 100 may be enclosed in a common housing, packaging, or the like, and may be interconnected or operably associated using one or more wired or wireless links. In other embodiments, for example, components of system 100 may be distributed among multiple or separate devices, may be implemented using a client/server configuration or system, may communicate using remote access methods, or the like.

System 100 may be adapted to perform formal verification and/or model checking of a design, e.g., a hardware or a software design (the “design under test”), for example, as described in detail below. System 100 may include one or more hardware and/or software components to perform one or more operations of the formal verification and/or model checking. Although embodiments of the invention are not limited in this respect, in some embodiments, the formal verification and/or model checking may include performing an analysis, e.g., an exhaustive analysis, of a design state-space in order to determine, across substantially all possible scenarios, whether the design under test obeys a predefined specification. For example, a PSL may be used to describe properties or assertions that are required to hold true, e.g., to evaluate to true, on the design under test.

In some demonstrative embodiments, system 100 may include a model-checking engine 140, such as a SAT-based or BDD-based engine. In some non-limiting embodiments, model-checking engine 140 may be implemented, for example, as an application, which may be stored and/or executed by one or more of processors 111, memory unit 112, and storage unit 113. Model-checking engine 140 may verify whether or not one or more input properties 161 are valid in a model provided as an input 141. Model-checking engine 140 may be used for model checking, for example, in order to expose flaws, “bugs”, error states, or otherwise erroneous behavior of the design. In some embodiments, model-checking engine 140 may perform bounded model checking.

In some demonstrative embodiments, a model 181, denoted M, may represent the design under test for formal verification. On the one hand, the time complexity of model checking a model depends exponentially on the number of inputs explored in the model. On the other hand, when a model violates a specification it is frequently the case that the values of only some of the inputs are important for triggering an erroneous behavior. Accordingly, it may be desirable to construct an underapproximation of the model 181 and to perform the model checking with relation to an underapproximated model 191, denoted M′, which has fewer inputs yet still allows error states to be reached, e.g., as described herein.

In some embodiments, system 100 may include an underapproximator 199 to automatically underapproximate model 181 by model 191, e.g., as described in detail below. For example, model 181 may have n inputs, and underapproximator 199 may determine or define, e.g., automatically, underapproximated model 191 having m<n inputs, e.g., as described in detail below.

In some embodiments, underapproximator 199 may apply to model 181 a mapping function resulting in underapproximated model 191, e.g., as described below. The mapping function may be generated, for example, by applying a Boolean function to a random system 196, e.g., as described in detail below.

In some demonstrative embodiments, the value of m may be defined by the user of system 100. For example, underapproximator 199 may receive the value of m as part of a user input 197. User input 197 may be received from the user, for example, via input 114 and/or may be maintained and/or stored in memory 112 and/or storage 113. Alternatively, in some embodiments, an initial value of m may be predefined based on any suitable criterion, for example, as a function of the number of inputs n. For example, in some embodiments an initial value of m may be set to n/5, n/10 or to any other value, e.g., corresponding to the value of n.

In some embodiments, input 141 may include underapproximated model 191; accordingly, model-checking engine 140 may check input properties 161 based on underapproximated model 191. A property φ of properties 161 may either pass or fail the model checking based on the underapproximated model M′; accordingly the model-checking engine 140 may generate pass/fail results at an output 142.

In some demonstrative embodiments, model checking engine 140 may generate a fail result 155 if the property φ fails the model checking of model 191, for example, if an error state of the model 191 has been reached, e.g., if model 191 does not satisfy the property φ. Fail result 155 may indicate that the model 181 likewise does not satisfy property φ, e.g., since model 191 is an underapproximation of model 181, as described herein. Thus, model-checking engine 140 may falsify model 181 based on underapproximated model 191.

In some demonstrative embodiments, model checking engine 140 may generate a valid result 145, for example, if the model M′ satisfies the property φ. In one example, result 145 may be a false positive result. Accordingly, in some embodiments, when the input properties 161 are found valid for the underapproximation model 191, then the underapproximation of model M may be refined as indicated at arrow 198, for example, by adding behaviors to the underapproximated model 191, e.g., automatically and/or based on information 197. Optionally, the refinement of the underapproximation may utilize user input information 197 to direct underapproximator 199. For example, user input information 197 may include information regarding sets of important inputs, interesting combinations of inputs, independent inputs, and/or the like. User input information 197 may be based, for example, on knowledge of a high-level design for the design-under-test.

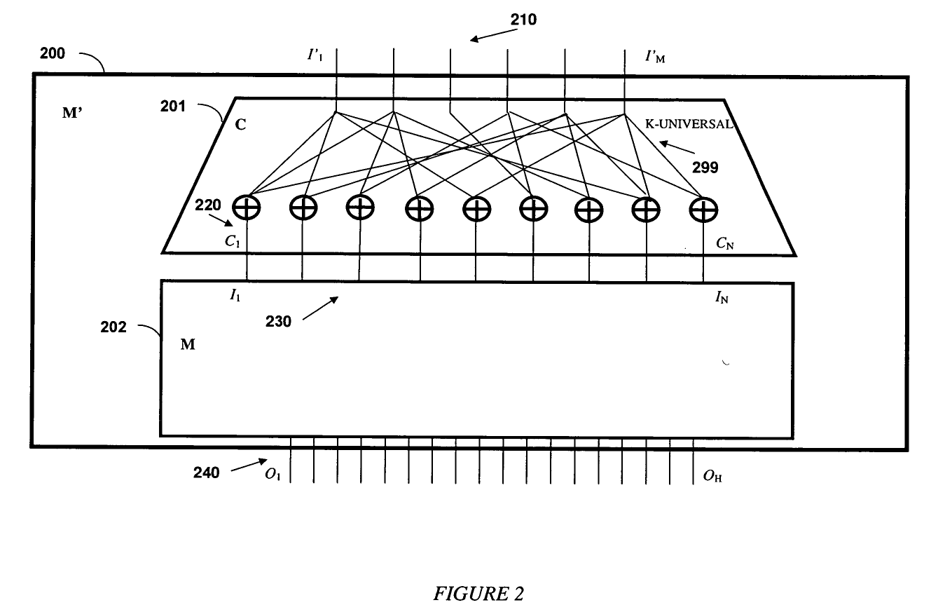

FIG. 2 schematically illustrates an underapproximated model 200 in accordance with a demonstrative embodiment of the invention.

In some demonstrative embodiments, underapproximated model 200 may include m inputs 210, denoted I′₁, through I′_{M}, respectively; and h outputs 240, denoted O₁ through O_{H}, respectively.

In some demonstrative embodiments, underapproximated model 200 may include or may be a combination of a model 202, e.g., of a design under test, having n inputs 230, denoted I₁ through I_{N}, respectively, wherein m is less than n; and a mapper 201 to map inputs 210 to inputs 230, e.g., as described herein.

Although embodiments of the invention are not limited in this respect, in some demonstrative embodiments, models 200 and/or 202 may include models 191 and/or 181 (FIG. 1), respectively. For example, mapper 201 may be implemented by an underapproximator, e.g., underapproximator 199 (FIG. 1), to automatically underapproximate model 200 by underapproximated model 202.

In some embodiments, model 200 and underapproximated model 202 may both have the same plurality of outputs 240.

In some embodiments, mapper 201 may implement a mapping function 299 to construct underapproximated model 200. For example, mapping function 299 may map the m inputs of model 200 to the n inputs of model 202. Mapping function 299 may be implemented, for example, by a Boolean circuit, denoted C, having m inputs corresponding to inputs 210, respectively; and n outputs 220 denoted C₁ through C_{N}, respectively, which may be respectively connected to n inputs 230 of model 202. In some demonstrative embodiments, mapping function 201 may be k-universal, wherein k is at least two. Accordingly, any assignment on any k out of n inputs 230 of model 202 may be achieved under some assignment on m inputs 210 of underapproximated model 200, e.g., as described herein.

In some embodiments, mapping function 299 may be based on a random construction, e.g., as described below, that provides a k-universal circuit with an arbitrarily high probability. For example, in some embodiments the parameter k may be almost linear in m, e.g., such that 2 k log n≦2 m and/or such that an upper bound on k is m-log log n. Accordingly, in some embodiments, mapper 201 may be constructed with nearly optimal parameters.

In some embodiments, mapping function 299 may be based on a random system, denoted RS, e.g., as defined below, and a Boolean function ƒ. Although embodiments of the invention are not limited in this respect, the random system RS may be implemented by random system 196 (FIG. 1). For example, in some embodiments, the Boolean function ƒ may be an exclusive or (XOR) function, denoted ⊕. In other embodiments, the function ƒ may include any other suitable function. The random system RS may be used to automatically select the m inputs of the underapproximated model M′, e.g., out of the n inputs of the original model M.

Although embodiments of the invention are not limited in this respect, in some demonstrative embodiments the random system RS may be formally defined, for example, as follows:

Let n, m be natural numbers such that 1≦m≦n. An (m, n)-Random System is a family RS=(S₁, S₂, . . . , Sₙ) of n uniformly chosen random subsets Sᵢ⊂{1, 2, . . . , m}. For example, for every i, 1≦i≦n, the set Sᵢ is chosen uniformly at random out of all 2^{m} possible subsets of {1, 2, . . . , m}. Each set Sᵢ may be chosen independently of other sets in the random system family RS.

In some embodiments, mapping function 299 and/or mapper 201 may be constructed, for example, as follows:

Define a Boolean function C=C(RS, ƒ) having a set of m inputs I_{C}={i₁, . . . , iₘ} and a set of n outputs O_{C}={c₁, . . . , cₙ};

For each index jε{1, . . . , n}, set the j-th input to be a randomly chosen set of inputs from the random system RS, e.g., I(cⱼ)={iₕ: hεSⱼ}; and

Set the corresponding j-th output to be the Boolean function ƒ e.g., the XOR function, applied to the j-th set of inputs, e.g., cⱼ=⊕(cⱼ)).

In some embodiments, if the random system RS has certain algebraic properties, e.g., if RS can be represented by an n×m Boolean matrix such that every k rows are linearly independent, then the resulting circuit C, e.g., as defined above, may be k-universal. For example, this may be demonstrated by the following lemma and the corresponding proof:

Lemma 1: Let A be an n×m Boolean matrix defined by the random system RS such that each entry aᵢⱼεA is “1” if jεSᵢ and “0” otherwise. Then, if every k rows of A are linearly independent, the circuit C=C(RS, ⊕) as above is k-universal.

Proof of Lemma 1: In some embodiments, the i-th output of the circuit C implements a XOR function on the inputs that correspond to the ‘1’ entries of the i-th row in the matrix A. Accordingly, the circuit C may be considered a linear transformation in a Galois Field GF(2) induced by multiplying the matrix A with the input vector, since addition in the field GF(2) is equivalent to the XOR operator. Accordingly, for every α₁ α₂ . . . αₘε{0, 1}^{m} and β₁ β₂ . . . βₙε{0, 1}ⁿ, it may hold that C(α₁ α₂ . . . αₘ)=β₁ β₂ . . . βₙ, for example, if and only if the following holds:

$$( \begin{matrix}{a}_{11} & {a}_{12} & … & {a}_{1 m} \\ {a}_{21} & {a}_{22} & … & {a}_{2 m} \\ ⋮ & & & ⋮ \\ {a}_{n 1} & {a}_{n 2} & … & {a}_{nm}\end{matrix} ) \times ( \begin{matrix}{α}_{1} \\ {α}_{2} \\ ⋮ \\ α m\end{matrix} ) = ( \begin{matrix}{β}_{1} \\ {β}_{2} \\ ⋮ \\ {β}_{n}\end{matrix} ) \qquad Equation ( 1 )$$

Let K={o₁, o₂, . . . oₖ}⊂{1, 2, . . . , n} be an arbitrary set of k outputs, and let βo1 βo2 . . . βok be any partial assignment on K. Then for any input vector α1 α2 . . . αm, the value C(α1 α2 . . . αm) restricted to K equals the output vector βo1 βo2 . . . βok, if and only if the following holds:

$$( \begin{matrix}{a}_{o 11} & {a}_{o 12} & … & {a}_{o 1 m} \\ {a}_{o 21} & {a}_{o 22} & … & {a}_{o2m} \\ ⋮ & & & ⋮ \\ {a}_{ok 1} & {a}_{ok 2} & … & {a}_{okm}\end{matrix} ) \times ( \begin{matrix}{α}_{1} \\ {α}_{2} \\ ⋮ \\ α m\end{matrix} ) = ( \begin{matrix}{β}_{o 1} \\ {β}_{o 2} \\ ⋮ \\ {β}_{ok}\end{matrix} ) \qquad Equation ( 2 )$$

Since every k rows in the matrix A are linearly independent, it follows that the restricted k×m matrix, denoted B, is invertible. Accordingly, an assignment α₁ α₂ . . . αₘ exists, and may be computed by the following equation:

$$( \begin{matrix}{α}_{1} \\ {α}_{2} \\ ⋮ \\ α m\end{matrix} ) = {( \begin{matrix}{a}_{o 11} & {a}_{o 12} & … & {a}_{o 1 m} \\ {a}_{o 21} & {a}_{o 22} & … & {a}_{o 2 m} \\ ⋮ & & & ⋮ \\ {a}_{ok 1} & {a}_{ok 2} & … & {a}_{okm}\end{matrix} )}^{- 1} \times ( \begin{matrix}{β}_{o 1} \\ {β}_{o 2} \\ ⋮ \\ {β}_{ok}\end{matrix} ) \qquad Equation ( 3 )$$

In some embodiments, a function and/or circuit C that is constructed as described above may be k-universal at an arbitrary high probability for relatively high values of the parameter k. For example, in some embodiments, function 299 may be k-universal with a probability of at least 1−δ, where δ>0 denotes a desired confidence parameter. For example, this may be demonstrated by the following lemma and the corresponding proof:

Lemma 2: Let k>1, a>1, b>1 be natural numbers and let δ>0 be a fixed confidence parameter. Set b=m/k and a=n/m. Let RS be a family of subsets in a (m, n)-Random System and let A be the underlying matrix, e.g., as described above. If b>log₂(e·ab(1/δ)^{1/k})+1, wherein e denotes the Euler constant, then with a probability of at least 1−δ every k rows in A are linearly independent.

In other words, Lemma 2 states that with a probability of 1−δ, every k rows in the matrix A defined by the random system RS are linearly independent. Accordingly, in some embodiments function 299 may be k-universal with a probability of at least 1−δ, for example, with parameters k<m<n such that:

$$\frac{m}{k} > log ( e \cdot \frac{n}{k} \cdot {( \frac{1}{δ} )}_{k}^{1} ) + 1. \qquad Equation ( 4 )$$

According to Lemma 2, if the parameters k, m, n satisfy Equation 4, then the underlying matrix A may have every k rows linearly independent with a probability of at least 1−δ. In addition, according to Lemma 1, if every k rows in matrix A are linearly independent, then a mapping function, e.g., function 299, which is constructed based on the random system RS as described above, may be k-universal.

In some embodiments, the number of inputs m and/or the degree of freedom k of underapproximated model 200 may be selected by a user, e.g., the user of system 100 (FIG. 1), such that the desired confidence parameter is met. For example, the value of m and/or of k may be provided to underapproximator 199 (FIG. 1) as part of user input 197 (FIG. 1), e.g., as described above.

In some demonstrative embodiments, Lemma 2 may be proven as follows: a random system RS, e.g., as described above, may be constructed such that every row in the corresponding matrix A may be a random Boolean vector of length m. Let K={o₁, o₂, . . . oₖ}⊂{1, 2, . . . , n} be any sequence of k rows in the matrix A. To determine the probability of k rows being linearly independent, define a sequence of event indicators, for example, such that Iⱼ=“1” if and only if the j-th row oⱼεK is a linear combination of the rows o₁, o₂, . . . , oⱼ₋₁. Under this definition, if

$$( {\sum }_{j = 1}^{k} {I}_{j} ) = 0$$

then the k rows in K are linearly independent. It is noted that for every index j, the j−1 preceding vectors may span a linear space of size at most 2^{j-1}. In addition, the probability of a row j being linearly independent of the previous j−1 rows is Pr[Iⱼ=0]≧(2^{m}−2^{j-1})/2^{m}, e.g., since the rows of matrix A are chosen uniformly at random and independently of each other.

According to the above, the following may hold:

$$\begin{matrix}Pr [ ( {\sum }_{j = 1}^{k} {I}_{j} ) = 0 ] = {\prod }_{j = 1}^{k} \frac{{2}^{m} - {2}^{j - 1}}{{2}^{m}} \\ = {\prod }_{j = 1}^{k} ( 1 - {2}^{j - 1 - m} ) \geq 1 - \\ {\sum }_{j = 1}^{k} {2}^{j - 1 - m} \geq 1 - {2}^{k - m}\end{matrix} \qquad Equation ( 5 )$$

For example, the inequalities in Equation 5 may be derived from the following known inequalities:

(i) Let x₁, x₂, . . . , xₙ be non-negative real numbers.
Then

$${\prod }_{i = 1}^{n} ( 1 - {x}_{i} ) > 1 - {\sum }_{i = 1}^{n} {x}_{i} \qquad Equation ( 6 )$$

(ii) Let m, k be naturals such that m>k. Then

$${\sum }_{i = 1}^{k} {2}^{i - m} \leq 2 \cdot {2}^{k - m}$$

Accordingly, in some embodiments a probability, denoted

$$Pr ⌊ ( {\sum }_{j = 1}^{k} {1}_{j} ) > 0 ⌋ ,$$

that the k rows in K are linearly independent may be determined as follows:

$$Pr ⌊ ( {\sum }_{j = 1}^{k} {I}_{j} ) > 0 ⌋ \leq {2}^{k - m}$$

There may be

$$( \begin{matrix}n \\ k\end{matrix} ) < {( \frac{en}{k} )}^{k}$$

possible sets K of k rows. By applying the Union Bound, e.g., for a countable set {A1, A2, A3, . . . } of events, Pr[∪ᵢ Aᵢ]≦Σᵢ Pr[Aᵢ], it may be concluded that in some embodiments, the probability that some set K of the k rows is not linearly independent is at most δ:

$${( \frac{en}{k} )}^{k} \cdot {2}^{k - m} = {( eab )}^{k} \cdot {2}^{( 1 - b ) k} \leq {( eab )}^{k} \cdot {2}^{- log ( {eab ( 1 / δ )}^{1 / k} ) \cdot k} = δ \qquad Equation ( 8 )$$

In some embodiments, function 299 may be k-universal with a high probability of success for a relatively high value of k, for example, for values of k that are nearly linear in m for all practical n, e.g., for k˜m/log(n/k). In other words, in some embodiments the value of δ may have negligible influence on k. For instance, for the sample values n=140, m=70 and δ=0.02, function 299 may be k=10-universal with a probability of at least 98 percent. According this example, the number of inputs of a model, e.g., the n inputs of model 200, may be reduced, e.g., by half, for example, from 140 to 70, by applying mapping function 299, while achieving a 10-universality in a very high probability.

In some embodiments, the parameter of universality k corresponding to given values of n and m may be higher than the lower bound on k as calculated above. For example, in some embodiments the requirement for universality may be relaxed to allow a better lower bound on the parameter k.

In some embodiments, function 299 may be “almost” k-universal, or (k,ε)-universal. That is, “almost” all subsets of k output bits (namely, at least a 1−ε fraction of the subsets of size k) may exhibit universality and take all 2^{k} possible assignments. For example, for the parameters δ=ε=0.01, then with probability 0.99, 99% of the subsets of size k=max(0, m−4) may take all 2^{k} possible assignments. As defined herein, a k-universal function may be equivalent to a (k,0)-universal function.

With this relaxation, in some embodiments function 299 and/or mapper 201 may be constructed as described above to be (k, ε)-universal with probability at least 1−δ for k=max(0, m−log(1/δ·δ)). Although embodiments of the invention are not limited in this respect, in some demonstrative embodiments a (k,ε)-universality may be formally defined as follows:

For m, n, k and C=C(RS, ⊕) as described above, given a subset K⊂{1, . . . , n} of k outputs, the subset K may be covered by the function C if, for example, for every partial assignment α_{K}ε{0, 1}^{k} on K, there is a full assignment αε{0, 1}^{m} on the inputs of C such that the restriction obeys C(α)|_{K}=α_{K}. Accordingly, the Boolean circuit C, e.g., as defined above, may be (k, ε)-universal if C covers at least

$$( 1 - ɛ ) ( \begin{matrix}n \\ k\end{matrix} )$$

subsets K⊂{1, . . . , n} of k outputs.

In some embodiments, the universality parameter k may achieve a value very close to the theoretical upper bound of m, for example, at a small sacrifice of universality and/or of confidence. This may provide a better lower bound for k in some embodiments, for example, as long as ε is not too small. For example, for δ=ε=0.1 and m≧7, the corresponding universality parameter may be k=m−7, namely, with probability of at least 90 percent, function 299 may be (max(0, m−7), 0.1)-universal. In comparison, with an only negligible sacrifice of universality and a very small failure probability such as, e.g., δ=ε=0.01, it may be possible to achieve (k, 0.01)-universality for k=max(0, m−14).

Although embodiments are not limited in this respect, the above result may be demonstrated by the following lemma, and the corresponding proof:

Lemma 3. Let m<n be natural numbers and let C=C(RS, ⊕) be a Boolean circuit as defined above. Fix 0<δ, 0<ε<1 and set k=max(0, m-log 1/(ε·δ)). Then the circuit C is (k, ε)-universal with probability at least 1−δ.

Proof (of Lemma 3). The following proof relates to an application of Markov's inequality on one of the consequences from the proof of Lemma 2. The following proof also relates the linearity property of expectation, e.g., as follows:
Markov inequality: Let X be a random variable assuming only non-negative values. Then for all

$$c > 0 , Pr [ X \geq c \cdot E [ X ] ] \leq \frac{1}{c} .$$

Linearity of Expectation: For any n random variables X₁, . . . , Xₙ the following holds:

$$E [ {\sum }_{i = 1}^{n} {X}_{i} ] = {\sum }_{i = 1}^{n} E [ {X}_{i} ] . )$$

For every subset K⊂{1, 2, . . . n} of size k, define X_{K} as a random-(0, 1) variable, such that X_{K}=“1” if and only if the subset K is not covered by the function C. Referring to the proof of Lemma 1, the set K is covered by the function C if and only if the sub-matrix B that corresponds to K has full rank, since otherwise the linear transformation is not injective. In addition, from the proof of Lemma 2, the probability of X_{K}=1 is known to obey Pr[X_{K}=1]≦2^{k-m}.

$$Let X = {\sum }_{K ⋐ ( 1 , … , n ) , \vert K \vert = k} {X}_{K} \qquad$$

be the sum of the random variables X_{K}. By linearity of expectation:

$$E [ X ] = {\sum }_{K} E [ {X}_{K} ] \leq ( \begin{matrix}n \\ k\end{matrix} ) \cdot {2}^{k - m} \qquad Equation ( 9 )$$

and by Markov's inequality,

$$Pr [ X > ɛ \cdot ( \begin{matrix}n \\ k\end{matrix} ) ] = Pr [ X \geq ɛ \cdot {2}^{m - k} \cdot ( \begin{matrix}n \\ k\end{matrix} ) \cdot {2}^{k - m} ] \leq \frac{1}{ɛ \cdot {2}^{m - k}} = δ \qquad Equation ( 10 )$$

Accordingly, it may be concluded that k≧m−log (1/(ε·δ)), as desired.

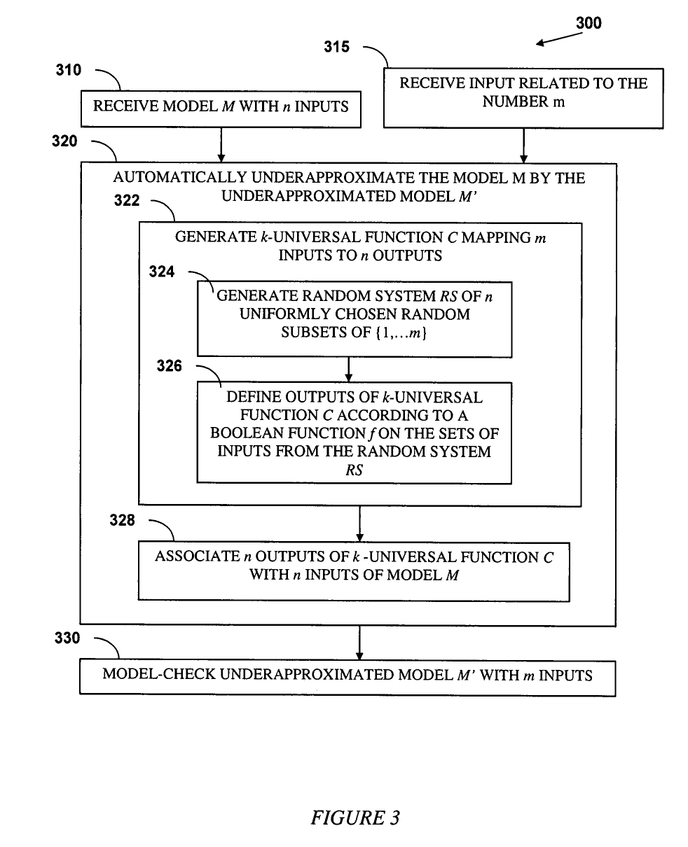

FIG. 3 is a schematic flow-chart of a method of underapproximated model checking in accordance with some demonstrative embodiments. Although embodiments of the invention are not limited in this respect, in some demonstrative embodiments, one or more operations of the method of FIG. 3 may be implemented, for example, by system 100 (FIG. 1), and/or by other suitable units, devices and/or systems.

As indicated at block 310, in some embodiments the method may include receiving a model M having n inputs (block 310). For example, underapproximator 199 (FIG. 1) may receive model 181 (FIG. 1), e.g., as described above.

As indicated at block 315, the method may include receiving an input, e.g., from a user, related to the number m. For example, underapproximator 199 (FIG. 1) may receive user input 197 (FIG. 1) including the number m defined by the user, e.g., as described above.

As indicated at block 320, the method may include automatically determining an underapproximated model M′ having m inputs, wherein m is less than n. For example, underapproximator 199 (FIG. 1) may underapproximate model 181 (FIG. 1) by underapproximated model 191 (FIG. 1), e.g., as described above.

As indicated at block 330, the method may include model-checking the underapproximated model M′. For example, model-checking engine 140 (FIG. 1) may perform model-checking operations on underapproximated model 191 (FIG. 1), e.g., as described above.

As indicated at block 322, in some embodiments automatically generating the underapproximated model M′ may include applying a mapping function, e.g., the k-universal mapping function C described above, to map the m inputs of underapproximated model M′ to the n inputs of model M. For example, underapproximator 199 (FIG. 1) may apply mapping function 299 (FIG. 2) to map the m inputs to the n inputs of model 181 (FIG. 1), e.g., as described above.

As indicated at block 324, applying the mapping function may include generating a random system RS of n uniformly chosen random subsets of {1, . . . m}, for example, as described above with reference to FIG. 2.

As indicated at block 326, in some embodiments applying the mapping function may include defining the outputs of the mapping function according to a Boolean function ƒ applied on the sets of inputs from the random system RS. For example, in some embodiments the function ƒ may include a XOR function, e.g., as described above.

As indicated at block 328, in some embodiments automatically generating an underapproximated model M′ may include associating the n outputs of the k-universal function C with the n inputs of model M. For example, the underapproximated model M′ may be constructed as follows, although embodiments are not limited in this respect:

Let {i₁, . . . , iₙ} be the primary inputs of the model M. Construct a k-universal function C based on a random system RS=(S₁, . . . , Sₙ). For each jε{1, . . . , n}, connect the j-th input of the model M to the j-th output of the k-universal function C. The inputs of the underapproximated model M′ are the m inputs of the k-universal function C; and the outputs of the underapproximated model M′ are the outputs of the original model M.

Other suitable operations may be used, and other suitable orders of operation may be used. One or more operations may be repeated, for example, for a pre-defined time period, for a pre-defined number of iterations, substantially continuously, at pre-defined time intervals, until a pre-defined condition holds true, or based on other criteria.

In some embodiments, an underapproximated model M′, e.g., model 191 (FIG. 1) and/or model 200 (FIG. 2), may be used for bounded model checking. For example, the system 100 (FIG. 1) and/or model-checking engine 140 (FIG. 1) may be configured to perform bounded model checking. The following table compares runtime in seconds until an error state is reached for 17 different designs of a model M having n inputs; with runtime in seconds until an error state is reached for an underapproximated model M′ having m inputs, for different values of m. A sign ‘−’ denotes that the error state was not found up to a bound of 100. ‘TO’ denotes a timeout of 6 hours.

TABLE 1

| | | | (PRG) m = . . . | | | |
|---|---|---|---|---|---|---|
| Design | inputs (n) | S | n/2 | n/3 | n/5 | n/10 |
| IBM#1 | 45 | 96 | 66 | 63 | 66 | 63 |
| IBM#2 | 76 | 173 | 149 | 76 | 72 | 68 |
| IBM#3 | 76 | 191 | 127 | 77 | 79 | — |
| IBM#4 | 85 | 211 | 170 | 121 | 105 | 140 |
| IBM#5 | 68 | 61 | 65 | 20 | 592 | — |
| IBM#6 | 68 | 73 | 59 | 14 | 661 | — |
| IRM#7 | 68 | 482 | 308 | 46 | 52 | — |
| IBM#8 | 68 | 122 | 152 | 16 | 90 | — |
| IBM#9 | 64 | 2101 | 1915 | 1966 | 1654 | 1208 |
| IBM#10 | 80 | 1270 | 1392 | 1830 | 1137 | — |
| IBM#11 | 83 | 2640 | 2364 | 2254 | 1845 | — |
| IBM#12 | 6 | 8201 | 7191 | — | — | — |
| IBM#13 | 60 | 942 | 453 | 432 | 351 | — |
| IBM#14 | 218 | 965 | 735 | 778 | 510 | 396 |
| IBM#15 | 52 | 1206 | — | — | — | — |
| IBM#16 | 157 | 953 | — | — | — | — |
| IBM#17 | 68 | 21503 | TO | TO | TO | TO |

As shown in Table 1, underapproximated model-checking in a bounded model checking environment may be more efficient, e.g., in terms of run-time, compared to model-checking without underapproximation, and may be substantially as effective at locating error states. As demonstrated by the experimental results of Table 1, a value of m=n/5 is high enough to find an error state in 13 out of 17 cases, and typically in less time comparing to the not-underapproximated ‘S’ column, despite the complexity of the XOR function in the k-universal circuit. Thus, in some embodiments, the automatic underapproximation method e.g., implemented by underapproximator 199 (FIG. 1), may use m=n/5 as an initial value of m, before any refinements, e.g., before refinement process 198 (FIG. 1).

In some embodiments, the contribution of the underapproximation may be measured by the number of “wins”, e.g., by the number of cases where an error state is successfully located, rather than by the average run-time. Accordingly, it is acceptable in some embodiments that such a method has no added value if the design satisfies the property.

Underapproximated model-checking in accordance with demonstrative embodiments of the invention, for example, where there is a measurable and/or uniform degree of freedom on the inputs, may be more effective than conventional methods, for example, where inputs are manually fixed (e.g., fixing n-m inputs to an arbitrary value) and/or grouped (e.g., grouping the inputs into m sets where and inputs in the same set are forced to be equal). For example, this may be demonstrated by the experimental results summarized in the following table, which compares the runtime in seconds until an error state is reached in the 17 designs of Table 1:

TABLE 2

| | | | (FIX) m = . . . | | | | (Group) m = . . . | | | |
|---|---|---|---|---|---|---|---|---|---|---|
| Design | inputs (n) | S | n/2 | n/3 | n/5 | n/10 | n/2 | n/3 | n/5 | n/10 |
| IBM#1 | 45 | 96 | 246 | — | — | — | 223 | 229 | 227 | 231 |
| IBM#2 | 76 | 173 | — | — | — | — | 361 | 446 | — | — |
| IBM#3 | 76 | 191 | 373 | — | — | — | 168 | 317 | — | — |
| IBM#4 | 85 | 211 | 191 | 317 | — | — | 306 | 289 | 405 | — |
| IBM#5 | 68 | 61 | — | — | — | — | 410 | — | — | — |
| IBM#6 | 68 | 73 | — | — | — | — | — | — | — | — |
| IBM#7 | 68 | 482 | — | — | — | — | 561 | 491 | — | — |
| IBM#8 | 68 | 122 | — | — | — | — | 113 | — | — | — |
| IBM#9 | 64 | 2101 | 1693 | — | — | — | 2150 | — | — | — |
| IBM#10 | 80 | 1270 | — | — | — | — | — | — | — | — |
| IBM#11 | 83 | 2640 | — | — | — | — | — | — | — | — |
| IBM#12 | 6 | 8201 | — | — | — | — | — | — | — | — |
| IBM#13 | 60 | 942 | 1206 | — | — | — | 413 | 407 | — | — |
| IBM#14 | 218 | 965 | — | — | — | — | 969 | 1102 | — | — |
| IBM#15 | 52 | 1206 | — | — | — | — | — | — | — | — |
| IBM#16 | 157 | 953 | — | — | — | — | — | — | — | — |
| IBM#17 | 68 | 21503 | — | — | — | — | TO | — | — | — |

As demonstrated by the experimental results of Table 2, both of the conventional methods require significantly more inputs in order to locate an error state than does the k-universal construction in accordance with embodiments of the invention.

In some embodiments, the underapproximated k-universal model checking may be implemented in unbounded model-checking systems, and or in simulation-based verification systems.

In some embodiments, the refinement process, e.g., refinement 198 (FIG. 1), may increase the value of m, for example, to add more behaviors to the underapproximated model. Optionally, the refinement process may be guided by additional and/or other parameters, for example, in the case of SAT-based model checking, an unsatisfiable core may guide refinement.

In some embodiments, k-universal underapproximation may be applied to an unrolled model, for example, in a bounded model-checking system where the inputs of each timeframe are represented by different variables. For example, underapproximated model M′ may be constructed with m inputs for 0<m<n·K, where K is the unrolling bound. This may result in locating error states with an even smaller set of input cycles.

Embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium include a semiconductor or solid-state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method of checking a model having a first number of inputs, the method comprising:
automatically underapproximating said model by an underapproximated model having a second number of inputs,
wherein said second number is smaller than said first number, and
wherein said automatically underapproximating comprises mapping said second number of inputs to said first number of inputs such that any possible combination of two or more values of any subset of two or more respective inputs of said first number of inputs is obtainable by assigning to each of one or more inputs of said second number of inputs a value of a predefined set of input values.

2. The method of claim 1, wherein said mapping comprises:
randomly selecting a random subset of said second number of inputs; and
mapping said subset of said second number of inputs to an input of said first number of inputs by applying a Boolean function to said random subset.

3. The method of claim 2, wherein said mapping comprises repeating said randomly selecting and mapping said subset for each of said first number of inputs.

4. The method of claim 2, wherein said Boolean function comprises an exclusive- or function.

5. The method of claim 1 comprising checking an input property of said model by applying said input property to said underapproximated model.

6. The method of claim 5 comprising falsifying said model if said underapproximated model does not satisfy said input property.

7. The method of claim 1, wherein said automatically underapproximating comprises automatically underapproximating based on a user input representing said second number.

8. A computing system capable of checking a model having a first number of inputs, the system comprising:
an underapproximator to automatically underapproximate said model with an underapproximated model having a second number of inputs by mapping said second number of inputs to said first number of inputs such that any possible combination of two or more values of any subset of two or more respective inputs of said first number of inputs is obtainable by assigning to each of one or more inputs of said second number of inputs a value of a predefined set of input values,
wherein said second number is smaller than said first number.

9. The computing system of claim 8, wherein said underapproximator is capable of mapping said second number of inputs to said first number of inputs by randomly selecting a random subset of said second number of inputs; mapping said subset of said second number of inputs to an input of said first number of inputs by applying a Boolean function to said random subset; and repeating said randomly selecting and mapping said subset for each of said first number of inputs.

10. The computing system of claim 9, wherein said Boolean function comprises an exclusive-or function.

11. The computing system of claim 8 comprising a model checking engine to check an input property of said model by applying said input property to said underapproximated model.

12. The computing system of claim 11, wherein said model checking engine is to falsify said model if said underapproximated model does not satisfy said input property.

13. The computing system of claim 8, wherein said underapproximator is capable of automatically underapproximating based on a user input representing said second number.

14. A computer program product comprising a computer-useable medium including a computer-readable program, wherein the computer-readable program when executed on a computer causes the computer to:
automatically underapproximate a model having a first number of inputs with an underapproximated model having a second number of inputs by mapping said second number of inputs to said first number of inputs such that any possible combination of two or more values of any subset of two or more respective inputs of said first number of inputs is obtainable by assigning to each of one or more inputs of said second number of inputs a value of a predefined set of input values,
wherein said second number is smaller than said first number.

15. The computer program product of claim 14, wherein the computer-readable program causes the computer to:
randomly select a random subset of said second number of inputs; and
map said subset of said second number of inputs to an input of said first number of inputs by applying a Boolean function to said random subset.

16. The computer program product of claim 15, wherein the computer-readable program causes the computer to repeat said randomly selecting and mapping said subset for each of said first number of inputs.

17. The computer program product of claim 15, wherein said Boolean function comprises an exclusive-or function.

18. The computer program product of claim 14, wherein the computer-readable program causes the computer to check an input property of said model by applying said input property to said underapproximated model.

19. The computer program product of claim 18, wherein the computer-readable program causes the computer to falsify said model if said underapproximated model does not satisfy said input property.

20. The computer program product of claim 14, wherein the computer-readable program causes the computer to automatically underapproximate said model with said underapproximated model based on a user input representing said second number.
